(19) United States
(12) Patent Application Publication
(10) Pub. No.: US 2003/0014352 A1
(43) Pub. Date: Jan. 16, 2003

(54) System and method for remarketing off lease items

(76) Inventor: Richard A. Marzan, Allison Park, PA (US)

Correspondence Address: Frence & Associates, 400 Broad Street, Pittsburgh, PA, 15143, US

(21) Appl. No.: 10/181,127

(22) PCT Filed: Jan. 14, 2001
(86) PCT No.: PCT/US01/00941

(51) Int. Cl. G06F 17/60

(52) U.S. Cl. 705/37

(57) ABSTRACT

An improved system and method for remarketing of off lease items. According to the invention, it is contemplated that the collection and transfer of informations is done electronically to the greatest extent possible, which facilitates handling of the information. Preferably, a global computer network such as the Internet is used to transfer the information. The system and method of remarketing off lease items additionally permits the electronic auctioning of the off lease items, and also permits the direct sale to end users of the off lease items.

### RELATED APPLICATIONS

This application claims priority from pending U.S. Provisional Application Ser. No. 60/176,202, filed on Jan. 14, 2000, which is hereby incorporated by reference.

### TECHNICAL FIELD

This invention is directed to a system and method for remarketing off lease items.

### BACKGROUND ART

For a variety of reasons, the leasing of items—rather than the outright purchase of items—is increasing by consumers. In a typical lease transaction, a finance company purchases the item and then leases (or rents) the use of the item to the consumer for the term of lease. At the end of the lease term, a number of things typically occur, including the consumer relinquishing possession of the item and the item being eventually being remarketed, or sold, by the finance company, which has always maintained title to the item.

This general process applies to any number of leased items, including but not limited to vehicles, both cars, trucks and buses; heavy equipment such as lifts, cranes, and fork lifts; construction vehicles; computers; and office equipment. It should be understood the leased items enumerated herein are intended to be exemplary and not limiting. The end of lease activity will now be described with reference to leased vehicle, although it should be understood that similar activity occurs no matter what the leased item is.

Typically, possession of a leased vehicle is relinquished by a consumer at an authorized agent of the finance company (generally an autmotive dealer whose has agreed to accept returns on behalf of the finance company). Information about the return is then conveyed by the agent to the finance company. Such information may include the fact the consumer has reliquished the vehicle and information about the condition of the vehicle. Photographs of the vehicle may be part of the information provided about the condition of the vehicle. Although digital photography may be used, the digital pictures are nonetheless manually associated with the appropriate vehicle. Typically, this information is provided to the finance company by non-electronic means, such as facsimile or overnight courier.

If the finance company determines any repair work should be performed on the vehicle, the return location typically handles the repair work. A transporter is notified, who arranges to have the vehicle transported from the return location to a location where the vehicle will be auctioned. Typically, the auction location is a commercial vehicle auction, conveniently located to the return location. It should be understood. however, that the auction location is selected by the finance company (the owner of the vehicle), and is not neccesarily the closed auction to the return location. It is then at the auction that the value of the vehicle is determined. Potential end users of the vechicles being sold are generally not well represented at such auctions. Rather, the attendees would typically include entities which would resell the vehicle after purchase at the auction.

While the preceeding paragraphs generally outline the physical process in the returning and remarketing of an off lease vehicle, they do not address the financial implications of the return, which will now be done. In the process described in the preceeding paragraphs, there are a number of entities who are compensated for their participation in the process. These entities include the return location, the transporter, and the auction location. Additional entities may also be compensated if they are involved in the process. The finance company may compensate each entity individually, or may compensate a limited number of entities with those entites compensating the other entities. An example of which would be the finance company compensating the return location for the services provided by the reutrn location and the transporter. However compensation is handled, the proceeds of the sale must be remitted to the finance company.

The process described in the preceeding paragraphs can be costly, lengthy, and inefficient: costly because of the compensation provided to the participants in the process and the other costs of the process: lengthy because of the time which may pass from the point the consumer returns the vehicle to settlement, e.g., the cycle time; and inefficient due to the need to sell the off the leased item at auction, and due to the inherent limitations of auctions, including whether those bidders who would potentially have the most interest in the leased item are indeed attending the auction. Thus, a need exists to decrease the costs associated with remarketing off leased items, shortening the cyle time of the transaction, and otherwise improving the efficiency of the remarketing process.

### DISCLOSURE OF THE INVENTION

In accordance with the present invention, there is provided a greatly improved system and method for remarketing off lease items, which also results in decreased costs, cycle time, and improved efficiency. According to the invention, it is contemplated that the collection and transfer of information be done electronically to the greatest extent possible, which facilitates handling of the information. Preferably, a global computer network such as the Internet is used to transfer the information. The system and method of remarkting off lease items additionally permits the electronic auctioning of the off lease items, and also permits the direct sale to end users of the off lease items.

In summary, one aspect of the invention provides a method of facilitating the valuation of at least one off lease item, said method comprising the steps of: providing an accessible electronic medium; formulating a description relating to at least one item and entering the description in the accessible electronic medium; facilitating access to the accesible electronic medium in a manner to permit at least one authorized user to access the description relating to the at least one item prior to undertaking the valuation of the at least one item.

Additionally, one aspect of the invention provides a system for facilitating the valuation of at least one off lease item, said system comprising: an accessible electronic medium: an arrangement for formulating a description relating to at least one item and for facilitating entry of the description into the accessible electronic medium; and an arrangement for facilitating access to the accesible electronic medium in a manner to permit at least one authorized user to access the description relating to the at least one item prior to undertaking the valuation of the at least one item.

Additionally, one aspect of the invention provides an apparatus for facilitating the valuation of at least one off lease item, said apparatus comprising: an arrangement for electronically formulating a description relating to at least one item; and an arrangement for permitting at least one authorized user to access the description relating to the at least one item prior to undertaking the valuation of the at least one item.

Additionally, one aspect of the invention provides a program storage device readable by machine for tangibly embodying a program of instructions executable by said machine to perform a method of facilitating the valuation of at least one off lease item, said method comprising the steps of: providing an accessible electronic medium; formulating a description relating to at least one item and entering the description in the accessible electronic medium; facilitating access to the accesible electronic medium in a manner to permit at least one authorized user to access the description relating to the at least one item prior to undertaking the valuation of the at least one item.

### BRIEF DESCRIPTION OF THE DRAWINGS

FIG. 1 is a flow chart depicting the overall process of a preferred embodiment of the present invention.

FIG. 2 is an overall system block diagram of a preferred embodiment of the present invention.

FIG. 3 is an overall system block diagram of another preferred embodiment of the present invention.

### MODES FOR CARRYING OUT THE INVENTING

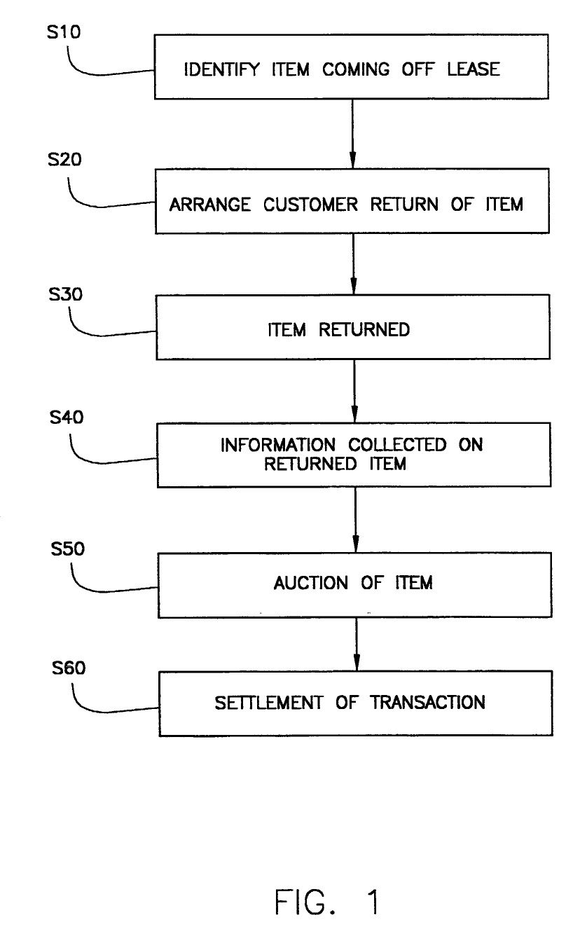

FIG. 1 is a flow chart depicting the overall process of a preferred embodiment of the present invention. The process starts with the identification of an item coming off lease at Step S10. Such identification may be done by either the owner of the item (i.e., the finance company) and provided to the system proprietor, or by the system proprietor using information provided by the item owner.

At Step S20, the customer return of the item is arranged. As before, the arrangement may be made with the customer by either the owner of the item (i.e., the finance company) and provided to the system proprietor, or by the system proprietor using information provided by the item owner.

At Step S30, the item is returned by the customer. The actual return may take place at an established return point, such as and automotive dealership where the leased item is a vehicle (the customer brings the item to the owner's agent), or at another mutually agreed place (the owner's agent goes to the item). Where the return occurs at non-established return point, depending on the nature of the item to be returned, it may be desirable to leave the item in place once the return has been accomplished.

As part of the return at Step S40, information is collected about the returned item. Such information should be a standard set of information which may vary depending upon the type of item. For example, where the item is a vehicle, the information may include the make and model of the vehicle, the vehicle style, the vehicle identification number (VIN), the vehicle mileage, an identification of the options present in the vehicle (power windows, power seats, tape player, CD player, air conditioning, etc.), damage to the vehicle, and pictures of the vehicle. The information which should be included is that information which potential purchasers would generally want to know about the item in order to decide to purchase the item.

Preferably, this information is captured electronically at the time the vehicle is reviewed or inspected. It is presently preferred that this information is captured using a portable personal computer with an integrated digital camera, such as a VAIO® C1 PictureBook™ notebook computer from Sony. Using such a portable personal computer permits the images to associated with the proper item at the time the image is taken. This greatly reduces the possibility of error, which may arise, for example, when the image is taken separately from the collection of other data, and then is later manually associated with the other data. It should also be recognized that a digital camera linked to a personal computer would also be preferred to subsequent manual association of the image with the data. The data which is collected in this Step is then preferably electronically transmitted to the system provider.

Based on this information, a decision may be made as to whether any repairs to the item are appropriate. If such repairs are appropriate, then suitable arrangements are made. Arrangements, however, need not necessarily be made for if no arrangements are made the price at auction will reflect the condition of the item and the need for repairs.

In Step S50, the item is auctioned This step may include a number of sub-steps, such as arranging for and transporting the item to the auction location, the auction itself, and reporting the results of the auction. Preferrably, the arrangements for the transportation of the item to the auction are accomplished electronically. Accordingly, a transporter may notified of the need to transport an item by electronic mail, or the transporter may electronically access the system provider to obtain the necessary information. The transporter may similarly keep the system provider apprised of the status of the transport. Handling the arrangements electronically also permits the auction location to have access to information regarding items being transported to the auction location. As before, this information may be provided by electronic mail, or the system provider may be electronically accessed to obtain the information. The transportation may also be arranged at the conlcusion of the auction, the auction being based on the information provided about the condition of the item. The auction is then conducted in the normal manner, and the results thereof are electronically reported to the system provider. As before, this information may be provided by electronic mail, or the system provider may be electronically accessed to provide the information. The results may either be provided in real time, or at some subsequent point in time.

At Step S60, the transaction is settled, that is funds are exchanged and all parties involved in the transaction are paid. Preferably, such settlement is done electronically. Settlement may occur immediately after the transaction, or it may occur at another time, for example at a given interval for regular participants in the transaction.

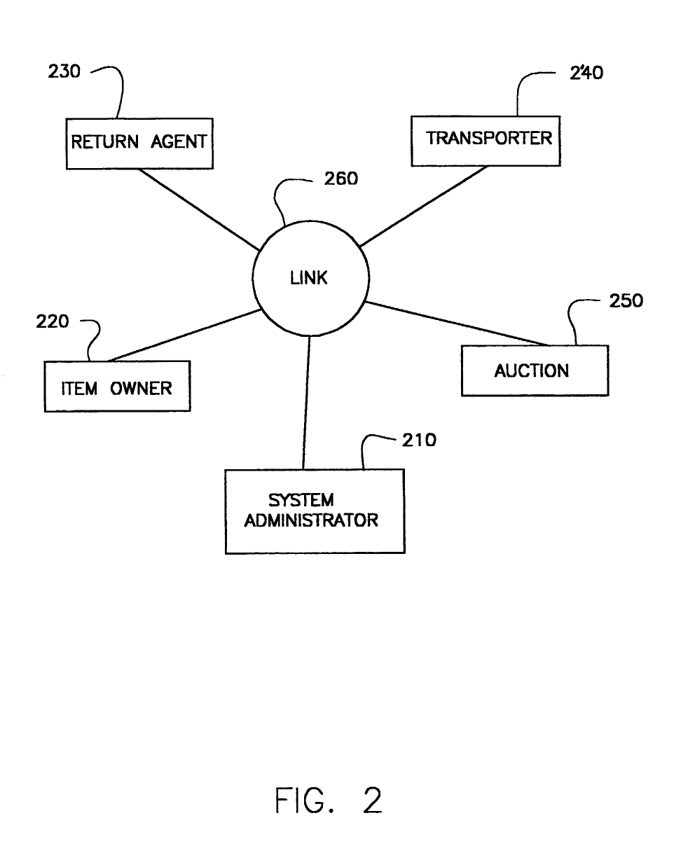

FIG. 2 is an overall system block diagram of a preferred embodiment of the present invention. In this embodiment, the participants in the transaction are linked to the system provider electronically. As shown, the linked particpants are system administrator 210, item owner 220 (typically the finance company; may also be viewed as the inventory supplier), return agent 230 (the agent accepting the returned item from the customer), transporter 240 (responsible for transportation of the item to the auction), and auction 250. Additional participants in the transaction, such as the purchaser and banking institutions, may also be linked. The link 260 between the participants does not have to be a physical link—it can, for example, be a link via a global computer network, such as the Internet, and include a virtual private network. Preferably, the link 260 is a global communications networks, such as the Internet. Use of a global communications network reduces the cost of implementing the present invention since a private communications network need not be provided, while increasing the geographic range of potential transaction participants. Alternatively, link 260 can be a private communications network, or other appropriate means, such as a direct dial modem connection. The link may also be a secure link, secured for example, through cryptography.

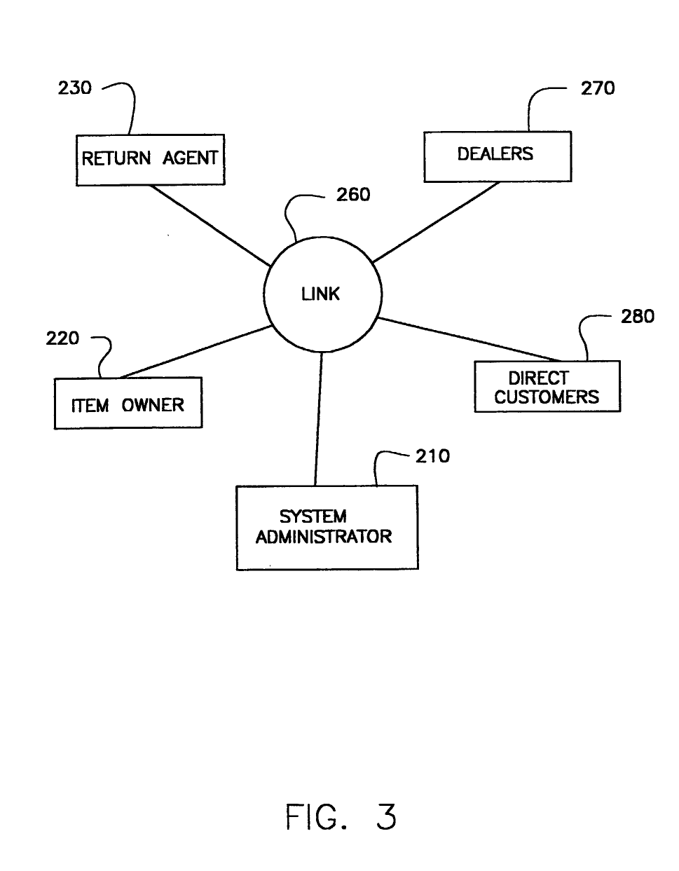

FIG. 3 is an overall system block diagram of another preferred embodiment of the present invention. As before, the participants in the transaction are linked to the system provider electronically. Moreover, like reference numerals are used to denote like components. As shown, the linked particpants are system administrator 210, item owner 220 (typically the finance company; may also be viewed as the inventory supplier), return agent 230 (the agent accepting the returned item from the customer), dealers 270, and direct customers 280. In contrast with FIG. 2, transporter 240 and auction 250 are not link; and dealers 270 and direct customers 280 are linked. Transporter 240 (responsible for transportation of the item to the auction), auction 250, and others, however, may also be linked if appropriate. In this embodiment, “dealers” 270 denotes resellers of vehicles who are authorized to participate in the system and direct customers 280 denotes potential end user purchasers. It should be understood that mutiple indivdual dealers and potential end purchasers are included in each designation. A return agent 230 may also be a dealers 270, for example, where the return agent is an automobile dealership.

This embodiment permits the conducting of auctions for items internally within the system. Participants in the auction for any particular items may include dealers 270 and direct customers 280, as permitted by the system administrator. Of course, the participants in the auction would be making their bids based upon the information collected about the returned item, since they would most likely be unable to view the physical item itself. While not shown in FIG. 3, transporter 240 could also be linked, if necessary, to transport the item between locations at any point in time. One advantage of this embodiment is that it permits the return agent 230, should the agent be so inclined, to have an opportunity to purchase the item. Conducting auctions internally within the system permit the potential purchasing pool to be greatly expanded, as the potential purchasers are no longer required to physically attend an auction site or participate in the auction by telephone.

Another feature of this embodiment is that it permits, over time as the system provider is able to track historical information, the ability to assign a value to a item based on comparable historical data. Assigning a value to an item, whether by using comparable historical data or otherwise, permits the system provider to sell, rather than auction, the items. Direct sale of items opens up the potential customer base to any customer able to link to the system provider. Where the link is provided through the Internet—as discussed above—this has the effect of greatly increasing the potential customer base.

While there have been described what are believed to be the preferred embodiments of the invention, those skilled in the art will recognize that other and further modifications may be made thereto without departing from the invention and it is intended to claim all such changes and modifications as fully within the scope of the invention.

What is claimed is:

1. A method of facilitating the valuation of at least one off lease item, said method comprising the steps of:
providing an accessible electronic medium;
formulating a description relating to at least one item and entering the description in the accessible electronic medium;
facilitating access to the accesible electronic medium in a manner to permit at least one authorized user to access the description relating to the at least one item prior to undertaking the valuation of the at least one item.

2. The method according to claim 1, wherein the off lease item comprises a vehicle.

3. The method according to claim 1, wherein the description of the at least one item comprises information relating to the physical condition of the at least one item.

4. The method according to claim 1, wherein the description of the at least one item comprises at least one visual representation of the at least one item.

5. The method according to claim 1, wherein the accessible electronic medium comprises a medium accessible via the Internet.

6. The method according to claim 1, wherein the accessible electronic medium comprises a portable electronic data storage unit.

7. The method according to claim 1, wherein said step of facilitating access comprises providing at least one security arrangement associated with the accessible electronic medium.

8. The method according to claim 7, wherein said step of providing at least one security arrangement comprises providing an electronic cryptographic arrangement associated with the accessible electronic medium.

9. The method according to claim 1, wherein the valuation of the at least one item comprises auctioning the at least one item.

10. A system for facilitating the valuation of at least one off lease item, said system comprising:
an accessible electronic medium;
an arrangement for formulating a description relating to at least one item and for facilitating entry of the description into the accessible electronic medium; and
an arrangement for facilitating access to the accesible electronic medium in a manner to permit at least one authorized user to access the description relating to the at least one item prior to undertaking the valuation of the at least one item.

11. The system according to claim 10, wherein the off lease item comprises a vehicle.

12. The system according to claim 10, wherein the description of the at least one item comprises information relating to the physical condition of the at least one item.

13. The system according to claim 10, wherein the description of the at least one item comprises at least one visual representation of the at least one item.

14. The system according to claim 10, wherein the accessible electronic medium comprises a medium accessible via the internet.

15. The system according to claim 10, wherein the accessible electronic medium comprises a portable electronic data storage unit.

16. The system according to claim 10, wherein said access facilitating arrangement comprises at least one security arrangement associated with the accessible electronic medium.

17. The system according to claim 16, wherein said at least one security arrangement comprises an electronic cryptographic arrangement associated with the accessible electronic medium.

18. Apparatus for facilitating the valuation of at least one off lease item, said apparatus comprising:
an arrangement for electronically formulating a description relating to at least one item; and
an arrangement for permitting at least one authorized user to access the description relating to the at least one item prior to undertaking the valuation of the at least one item.

19. The apparatus according to claim 18, wherein the off lease item comprises a vehicle.

20. The apparatus according to claim 18, wherein the description of the at least one item comprises information relating to the physical condition of the at least one item.

21. The apparatus according to claim 18, wherein the description of the at least one item comprises at least one visual representation of the at least one item.

22. The apparatus according to claim 18, wherein the accessible electronic medium comprises a medium accessible via the internet.

23. The apparatus according to claim 18, wherein the accessible electronic medium comprises a portable electronic data storage unit.

24. The apparatus according to claim 18, wherein said access facilitating arrangement comprises at least one security arrangement associated with the accessible electronic medium.

25. The apparatus according to claim 18, wherein said at least one security arrangement comprises an electronic cryptographic arrangement associated with the accessible electronic medium.

26. A program storage device readable by machine for tangibly embodying a program of instructions executable by said machine to perform a method of facilitating the valuation of at least one off lease item, said method comprising the steps of:
providing an accessible electronic medium;
formulating a description relating to at least one item and entering the description in the accessible electronic medium;
facilitating access to the accesible electronic medium in a manner to permit at least one authorized user to access the description relating to the at least one item prior to undertaking the valuation of the at least one item.
